(19) United States
(12) Patent Application Publication
(10) Pub. No.: US 2006/0153565 A1
(43) Pub. Date: Jul. 13, 2006

(54) Hybrid passive optical network

(75) Inventors: Sung-Bum Park, Suwon-si (KR); Chang-Sup Shim, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/270,110

(22) Filed: Nov. 9, 2005

(30) Foreign Application Priority Data
Jan. 12, 2005 (KR) 2005-2943

(51) Int. Cl. H04J 14/00

(52) U.S. Cl. 398/71

(57) ABSTRACT

A hybrid passive optical network (PON) includes a central office (CO) for multiplexing at least one downstream optical signal for broadcasting and a plurality of downstream optical signals for communication. The PON further includes a remote node (RN) connected to the CO using at least one feeder fiber (FF), and a plurality of optical network units (ONUs), each connected to the RN using at least one distribution fiber (DF). The RN demultiplexes the multiplexed downstream optical signal received from the CO into the downstream optical signal for broadcasting and the downstream optical signals for communication, and multi-splits the downstream optical signal for broadcasting. The RN transmits each split broadcasting downstream optical signal and its corresponding downstream optical signal for communication to each ONU.

### CLAIM FOR PRIORITY

This application claims priority under 35 U.S.C. §119 to an application entitled “Hybrid Passive Optical Network,” filed in the Korean Intellectual Property Office on Jan. 12, 2005 and assigned Serial No. 2005-2943, the contents of which are incorporated herein by reference.

### BACKGROUND OF THE INVENTION

1. Field of the Invention

The present invention relates generally to a passive optical network (PON), and in particular, to a hybrid PON supporting communication and broadcasting services.

2. Description of the Related Art

A passive optical network (PON) is a communication network in which a central office (CO) is connected to optical network units (ONUs) using optical fibers to transceive information based on optical signals. The signals can accommodate broadcasting, very high speed information, and additional communication services desired by a subscriber. In general, a PON has a star structure in which the CO is connected to each remote node (RN) installed locally within the neighborhood of subscribers using a feeder fiber (FF). Each RN is connected to ONUs using independent distribution fibers (DFs). PONs can roughly be classified into time division multiplexing (TDM) schemes and a wavelength division multiplexing (WDM) schemes. In TDM, a plurality of subscribers shares an optical signal having a single wavelength that has been time-divided into a plurality of timeslots. In WDM, each subscriber communicates using an optical signal having an independent wavelength allocated thereto. In a WDM-PON, a multiplexed, downstream, optical signal is transmitted to an RN using an FF and demultiplexed into a plurality of optical signals by a wavelength division multiplexer (WDM) located at the RN, and then each demultiplexed optical signal is transmitted to a corresponding ONU using a corresponding DF. Conversely, an optical signal output from each ONU is transmitted to the RN, and optical signals input to the WDM located at the RN are multiplexed and transmitted to the CO. In a TDM-PON, an optical signal having a single wavelength is transmitted to an RN using an FF and multi-split by a beam splitter (BS) located at the RN, and then each split optical signal is transmitted to a corresponding ONU using a corresponding DF. The upstream optical signal output from each ONU is transmitted to the RN, and optical signals input to the BS located at the RN are multiplexed (or combined) and transmitted to the CO.

Recently, in order to take advantage of the two schemes and accommodate more subscribers in a CO, a WDM/TDM scheme has been proposed. Optical signals of different wavelengths are used, and the TDM scheme is applied to each optical signal. A known WDM/TDM-PON is structured like a typical TDM-PON. A BS located at an RN thus distributes an input multiplexed optical signal to each of the ONUs. Each ONU filters out for its use an optical signal having a wavelength allocated to the ONU and selectively receives an allocated timeslot from the filtered optical signal having the allocated wavelength.

A WDM/SCM-PON in which a subcarrier multiplexing (SCM) technique for carrying a plurality of subcarriers on one wavelength is introduced. In the WDM/TDM-PON or WDM/SCM-PON, more subscribers can be accommodated by using a plurality of wavelengths and applying the TDM or SCM scheme to each wavelength.

According to development of broadcasting and communication convergence technology, a hybrid PON supporting broadcasting and communication services has been recently required.

FIG. 1 is a block diagram of a typical hybrid WDM-PON 10. The hybrid WDM-PON 10 includes a CO 20 connected to a broadcasting network and a communication network, an RN 30, and first to 32^{nd} ONUs 60-1 to 60-32.

The CO 20 multiplexes first to 64^{th} downstream optical signals having different frequencies and transmits the multiplexed downstream optical signal to the RN 30. In the illustrated embodiment, the first to 32^{nd} downstream optical signals are used for communication, and the 33^{rd} to 64^{th} downstream optical signals are used for broadcasting. The CO 20 receives a multiplexed upstream optical signal from the RN 30. A first wavelength band is equally allocated to the first to 32^{nd} downstream optical signals and first to 32^{nd} upstream optical signals, a second wavelength band is allocated to the 33^{rd} to 64^{th} downstream optical signals. The RN 30 includes first and second WDMs 40 and 50. The first WDM 40 demultiplexes the multiplexed downstream optical signal into the first to 64^{th} downstream optical signals and transmits the demultiplexed downstream optical signals to the first to 32^{nd} ONUs 60-1 to 60-32. The 32^{nd} ONU 60-32 receives the 32^{nd} optical signal and the 64^{th} optical signal. The second WDM 50 multiplexes the first to 32^{nd} upstream optical signals received from the first to 32^{nd} ONUs 60-1 to 60-32 and transmits the multiplexed upstream optical signal to the CO 20.

However, the hybrid WDM-PON 10 is a high cost structure. In particular, the addition of new subscriber to the broadcasting service entails an additional wavelength. Also, two WDMs 40, 50 and many optical fibers are needed.

### SUMMARY OF THE INVENTION

The present invention is directed to substantially solving at least the above problems and/or disadvantages. Accordingly, an object of the present invention is to provide a hybrid passive optical network in which communication and broadcasting services can be provided to more subscribers and with a cheaper structure.

According to one aspect of the present invention, there is provided a hybrid passive optical network (PON) that includes a central office (CO) for multiplexing at least one downstream optical signal for broadcasting and a plurality of downstream optical signals for communication. The PON has a remote node (RN) connected to the CO using at least one feeder fiber (FF). The PON further includes a plurality of optical network units (ONUs), each connected to the RN using at least one distribution fiber (DF), such that the RN demultiplexes the multiplexed downstream optical signal received from the CO into the downstream optical signal for broadcasting and the downstream optical signals for communication. The RN also multi-splits the downstream optical signal for broadcasting, and transmits each split broadcasting downstream optical signal and its corresponding downstream optical signal for communication to each ONU.

### BRIEF DESCRIPTION OF THE DRAWINGS

The above features and advantages of the present invention will become more apparent from the following detailed description when taken in conjunction with the accompanying drawings in which the same or similar elements are denoted by the same reference numbers throughout the several views:

FIG. 1 is a block diagram of a typical hybrid WDM-PON;

FIG. 2 is a block diagram of a hybrid WDM/TDM-PON according to a first preferred embodiment of the present invention;

FIG. 3 is a diagram illustrating wavelength bands used in the hybrid WDM/TDM-PON shown in FIG. 2;

FIG. 4 is a block diagram of an ONU according to another preferred embodiment of the present invention;

FIG. 5 is a block diagram of a hybrid WDM/TDM-PON according to a second preferred embodiment of the present invention;

FIG. 6 is a diagram illustrating wavelength bands used in the hybrid WDM/TDM-PON shown in FIG. 5; and

FIG. 7 is a block diagram of an ONU according to another preferred embodiment of the present invention.

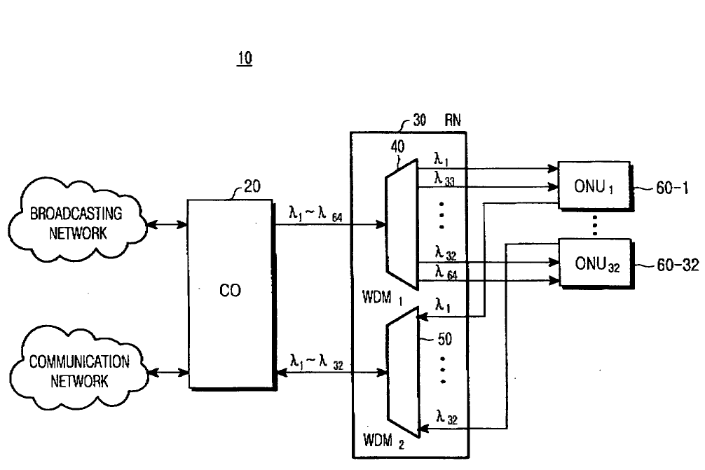

### DETAILED DESCRIPTION

In the following discussion, details of well-known functions or constructions are omitted for clarity of presentation.

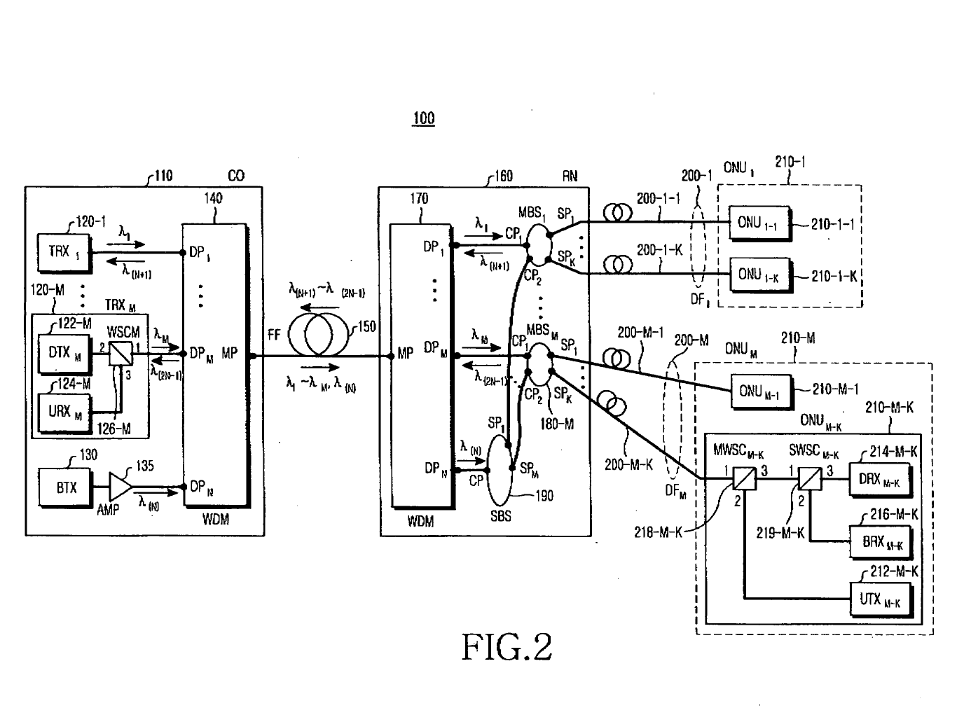

FIG. 2 is a block diagram showing, by way or illustrative and non-limitative example, a hybrid wavelength division multiplexing/time division multiplexing passive optical network (WDM/TDM-PON) 100 according to a first preferred embodiment of the present invention. Referring to FIG. 2, the hybrid WDM/TDM-PON 100 includes a central office (CO) 110, a remote node (RN) 160 connected to the CO 110 using a feeder fiber (FF) 150, first to M*K^{th} optical network units (ONUs) 210-1-1 to 210-M-K connected to the RN 160 on a point-to-point basis using first to M*K^{th} distribution fibers (DFs) 200-1-1 to 200-M-K, where M and K are predetermined natural numbers. The CO 110 multiplexes and transmits first to M^{th} downstream optical signals for communication. The CO 110 also multiplexes and transmits an N^{th} downstream optical signal for broadcasting and receives a multiplexed upstream optical signal, where N is a variable assumed equal to M+1 and introduced to distinguish upstream from downstream signals. The RN 160 demultiplexes the multiplexed downstream optical signal received from the CO 110 into the first to M^{th} downstream optical signals having different frequencies and the N^{th} downstream optical signal. The RN 160 then distributes the demultiplexed downstream optical signals to the ONUs 210-1-1 to 210-M-K. The RN 160 also multiplexes first to M^{th} upstream optical signals having different frequencies received from the ONUs 210-1-1 to 210-M-K, and transmits the multiplexed upstream optical signal to the CO 110. Each of the ONUs 210-1-1 to 210-M-K receives corresponding downstream optical signals from the RN 160, and transmits corresponding upstream optical signals to the RN 160.

The CO 110 includes first to M^{th} optical transceivers (TRXs) 120-1 to 120-M, a broadcasting optical transceiver (BTX) 130, an optical amplifier (AMP) 135, and a multiplexer/demultiplexer (MUX/DEM) 140.

The first to M^{th} TRXs 120-1 to 120-M have the same structure, where the M^{th} TRX 120-M includes an M^{th} downstream transmitter (DTX) 122-M for outputting the M^{th} downstream optical signal having an M^{th} waveform λ_{M}, an M^{th} upstream receiver (URX) 124-M for optoelectronic-converting a (2N−1)^{th} upstream optical signal having a (2N−1)^{th} waveform λ_{2N-1}, and an M^{th} wavelength selective coupler (WSC) 126-M for outputting an input upstream or downstream optical signal through its corresponding port. The M^{th} WSC 126-M has first to third ports, where the first port is connected to an M^{th} demultiplexing port (DP) of the MUX/DEM 140, the second port is connected to the M^{th} DTX 122-M, and the third port is connected to the M^{th} URX 124-M. The M^{th} WSC 126-M outputs the M^{th} downstream optical signal input through the second port through the first port and outputs the (2N−1)^{th} upstream optical signal input through the first port through the third port. The M^{th} downstream optical signal is constituted of first to K^{th} timeslots forming one cycle, where the K^{th} timeslot is allocated to the K^{th} ONU 210-M-K of an M^{th} group 210-M.

The AMP 135 amplifies the N^{th} downstream optical signal input from the BTX 130 with a preset gain and outputs the amplified N^{th} downstream optical signal to an N^{th} DP of the MUX/DEM 140. The AMP 135 may include an erbium doped fiber amplifier (EDFA) including an erbium doped fiber (EDF), a laser diode outputting pumping light for pumping the EDF, and a WSC for providing the pumping light to the EDF.

The MUX/DEM 140 includes a multiplexing port (MP) connected to the FF 150. The first to N^{th} DPs of the MUX/DEM 140 are connected one-to-one to the first to M^{th} TRXs 120-1 to 120-M and the AMP 135. The MUX/DEM 140 multiplexes downstream optical signals input through the first to N^{th} DPs, and outputs the multiplexed downstream optical signal through the MP. The MUX/DEM 140 also demultiplexes a multiplexed upstream optical signal input through the MP, and outputs the demultiplexed upstream optical signals through the first to N^{th} DPs. The MUX/DEM 140 may include a 1×N arrayed waveguide grating (AWG).

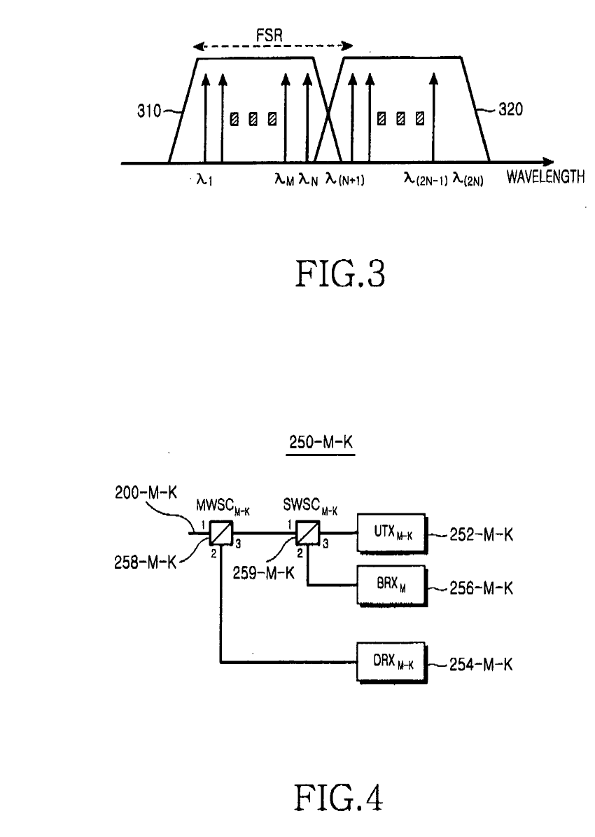

FIG. 3 is a diagram illustrating wavelength bands used in the hybrid WDM/TDM-PON 100 of FIG. 2. Referring to FIG. 3, a downstream wavelength band 310 and an upstream wavelength band 320 do not overlap. Each of the downstream and upstream wavelength bands 310, 320 is constituted of N wavelengths, each separated by a preset wavelength interval. Each bandwidth of the downstream and upstream wavelength bands 310, 320 has a length equal to a free spectral range (FSR) of the MUX/DEM 140 in order for the MUX/DEM 140 to process both the downstream and upstream wavelength bands.

If necessary, the downstream and upstream wavelength bands 310, 320 can be separated by an interval whose length is an integer times the FSR. The downstream optical signal for broadcasting can be included in a downstream wavelength band constituted of 2N^{th} to (3N−1)^{th} wavelengths, each separated by the wavelength interval, where the downstream optical signal for broadcasting has the (3N−1)^{th} wavelength.

In addition, the downstream and upstream wavelength bands 310, 320 can be exchanged.

The RN 160 includes a MUX/DEM 170, first to M^{th} main beam splitters (MBSs) 180-1 to 180-M, and a secondary beam splitter (SBS) 190.

The MUX/DEM 170, which includes an MP connected to the FF 150 and first to N^{th} DPs, demultiplexes a multiplexed downstream optical signal input through the MP, and then outputs the demultiplexed downstream optical signals through the first to N^{th} DPs. The MUX/DEM 170 multiplexes (N+1)^{th} to (2N−1)^{th} upstream optical signals input through the first to M^{th} DPs, and then outputs the multiplexed upstream optical signal through the MP. The MUX/DEM 170 also outputs the M^{th} downstream optical signal through the M^{th} DP and outputs the N^{th} downstream optical signal through the N^{th} DP. The MUX/DEM 170 may include a 1×N AWG.

The first to M^{th} MBSs 180-1 to 180-M, which have the same structure, are connected one-to-one to the first to M^{th} DPs of the MUX/DEM 170, such that the M^{th} MBS 180-M is connected to the M^{th} DP of the MUX/DEM 170. The first to M^{th} MBSs 180-1 to 180-M are also connected to the SBS 190. The M^{th} MBS 180-M includes first and second coupling ports (CPs) on one end and first to K^{th} split ports (SPs) on the other end. The first CP is connected to the M^{th} DP of the MUX/DEM 170, the second CP is connected to the SBS 190, and the first to K^{th} SPs are connected one-to-one to first to K^{th} DFs 200-M-1 to 200-M-K of an M^{th} group 210-M, where the K^{th} SP is connected to the K^{th} DF 200-M-K. The M^{th} MBS 180-M equally power-splits each of the M^{th} and N^{th} downstream optical signals into K downstream optical signals, and then outputs the K power-split downstream optical signals through the first to K^{th} SPs, respectively. The M^{th} MBS 180-M multiplexes (or combines) upstream optical signals having a (2N−1)^{th} wavelength input through the first to K^{th} SPs, and outputs the multiplexed (2N−1)^{th} upstream optical signal through the first CP.

The SBS 190 includes a CP on one end and first to M^{th} SPs on the other end. The CP is connected to the N^{th} DP of the MUX/DEM 170, and the first to M^{th} SPs are connected one-to-one to first to M^{th} MBSs 180-1 to 180-M, such that the M^{th} SP is connected to the M^{th} MBS 180-M. The SBS 190 equally power-splits the N^{th} downstream optical signal input through the CP into M downstream optical signals and outputs the M power-split downstream optical signals through the first to M^{th} SPs, respectively.

The first to M*K^{th} ONUs 210-1-1 to 210-M-K, which have the same structure, are classified into first to M^{th} groups 210-1 to 21 0-M. The M^{th} group 210-M is connected to the M^{th} MBS 180-M and includes first to K^{th} ONUs 210-M-1 to 210-M-K.

The K^{th} ONU 210-M-K of the M^{th} group 210-M includes a K^{th} upstream transmitter (UTX) 212-M-K for outputting an upstream optical signal having the (2N−1)^{th} wavelength at an allocated K^{th} timeslot. It also includes a K^{th} downstream receiver (DRX) 214-M-K for selectively receiving a downstream optical signal corresponding to the allocated K^{th} timeslot from the input M^{th} downstream optical signal and optoelectronic-converting the received downstream optical signal. It further includes a K^{th} broadcasting receiver (BRX) 216-M-K for receiving and optoelectronic-converting the input N^{th} downstream optical signal. As to couplers, the ONU 210-M-K has a K^{th} main WSC (MWSC) 218-M-K for outputting an input upstream or downstream optical signal through its corresponding port, and a K^{th} secondary WSC (SWSC) 219-M-K for separating the M^{th} downstream optical signal for communication and the N^{th} downstream optical signal for broadcasting.

The K^{th} MWSC 218-M-K has first to third ports, where the first port is connected to the K^{th} DF 200-M-K of the M^{th} group 210-M, the second port is connected to the K^{th} UTX 212-M-K, and the third port is connected to a first port of the K^{th} SWSC 219-M-K. The K^{th} MWSC 218-M-K outputs the M^{th} and N^{th} downstream optical signals input through the first port through the third port and outputs, through its first port, the (2N−1)^{th} upstream optical signal input through the second port.

The K^{th} SWSC 219-M-K has first to third ports, where the first port is connected to the third port of the K^{th} MWSC 218-M-K, the second port is connected to the K^{th} BRX 216-M-K, and the third port is connected to the K^{th} DRX 214-M-K. The K^{th} SWSC 219-M-K outputs the M^{th} downstream optical signal of the M^{th} and N^{th} downstream optical signals input through the first port through the third port, so that the N^{th} downstream optical signal remains, and outputs the remaining N^{th} downstream optical signal through the second port.

If necessary, an optical isolator can be inserted between the N^{th} DP of the MUX/DEM 170 included in the RN 160 and the SBS 190, in order to suppress crosstalk between upstream optical signals. More specifically, in a case where each of the first to M^{th} MBSs 180-1 to 180-M outputs each upstream optical signal input through the first to K^{th} SPs through the first and second CPs by dividing it equally, the optical isolator can block the (N+1)^{th} to (2N−1)^{th} upstream optical signals output from the CP of the SBS 190.

Though the TDM scheme is illustrated in the present embodiment, the SCM scheme can be selected. In that case, the upstream and downstream transmitters and the upstream and downstream receivers would be configured to transmit and receive SCM, rather than TDM, optical signals. In addition, the ONU is not limited to the present embodiment and can be configured variously by making processing wavelengths of the MWSC and the SWSC different.

FIG. 4 is a block diagram of a K^{th} ONU 250-M-K of an M^{th} group according to another preferred embodiment of the present invention. Referring to FIG. 4, the K^{th} ONU 250-M-K can be substituted for the K^{th} ONU 210-M-K of the M^{th} group 210-M shown in FIG. 2. The K^{th} ONU 250-M-K includes a K^{th} UTX 252-M-K for outputting a (2N−1)^{th} upstream optical signal at an allocated K^{th} timeslot, a K^{th} DRX 254-M-K for selectively receiving a downstream optical signal corresponding to the allocated K^{th} timeslot from the input M^{th} downstream optical signal and optoelectronic-converting the received downstream optical signal, a K^{th} BRX 256-M-K for receiving and optoelectronic-converting the input N^{th} downstream optical signal, a K^{th} MWSC 258-M-K for outputting an input upstream or downstream optical signal through its corresponding port, and a K^{th} SWSC 259-M-K for outputting a upstream optical signal for communication and a downstream optical signal for broadcasting to their corresponding ports, respectively.

The K^{th} MWSC 258-M-K has first to third ports, where the first port is connected to the K^{th} DF 200-M-K of the M^{th} group 210-M, the second port is connected to the K^{th} DRX 254-M-K, and the third port is connected to a first port of the K^{th} SWSC 259-M-K. The K^{th} MWSC 258-M-K outputs the M^{th} downstream optical signal input through the first port through the second port, and correspondingly outputs the N^{th} downstream optical signal input through the first port through the third port. The (2N−1)^{th} upstream optical signal, input through the third port, is outputted through the first port.

The K^{th} SWSC 259-M-K has first to third ports, where the first port is connected to the third port of the K^{th} MWSC 258-M-K, the second port is connected to the K^{th} BRX 256-M-K, and the third port is connected to the K^{th} UTX 252-M-K. The K^{th} SWSC 259-M-K outputs the N^{th} downstream optical signal input through the first port through the second port and outputs the (2N−1)^{th} upstream optical signal input through the third port through the first port.

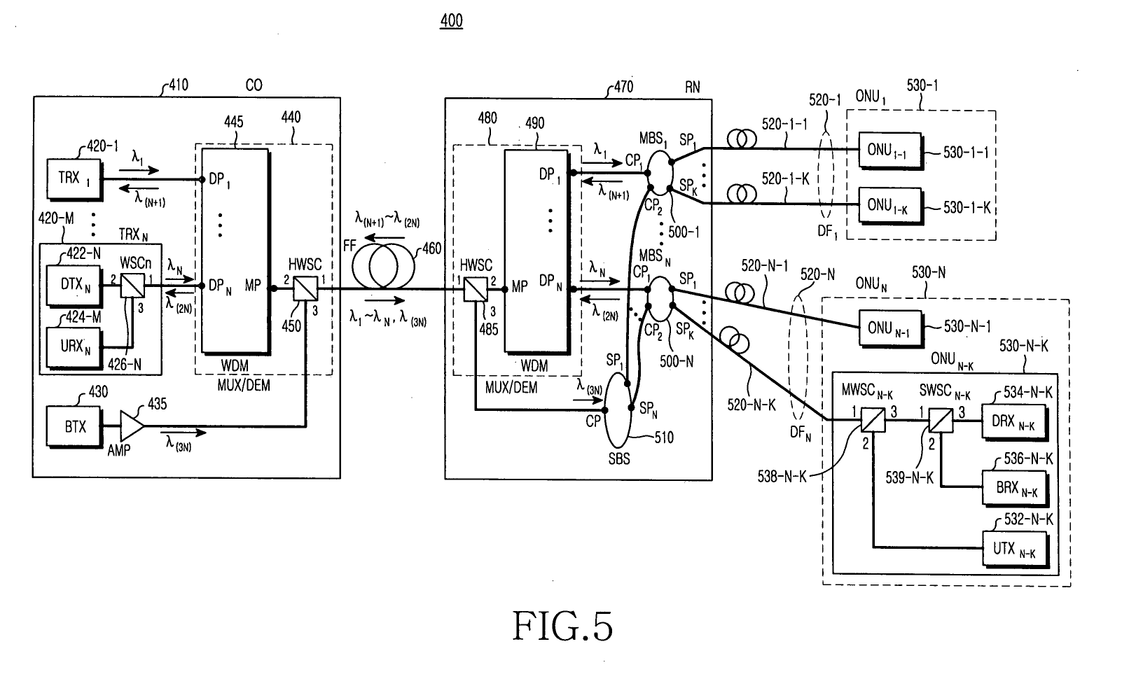

FIG. 5 is a block diagram of a hybrid WDM/TDM-PON 400 according to a second preferred embodiment of the present invention. The hybrid WDM/TDM-PON 400 includes a CO 410, an RN 470 connected to the CO 410 using an FF 450, first to N*K^{th} ONUs 530-1-1 to 530-N-K connected point-to-point to the RN 470 using first to N*K^{th} DFs 520-1-1 to 520-N-K, where N and K are predetermined natural numbers. The CO 410 multiplexes and transmits first to N^{th} downstream optical signals for communication and a 3N^{th} downstream optical signal for broadcasting, and receives a multiplexed upstream optical signal. The RN 470 demultiplexes the multiplexed downstream optical signal received from the CO 410 into the first to N^{th} downstream optical signals having different frequencies and the 3N^{th} downstream optical signal, distributes the demultiplexed downstream optical signals to the ONUs 530-1-1 to 530-N-K, multiplexes (N+1)^{th} to 2N^{th} upstream optical signals having different frequencies received from the ONUs 530-1-1 to 530-N-K, and transmits the multiplexed upstream optical signal to the CO 410. Each of the ONUs 530-1-1 to 530-N-K receives corresponding downstream optical signals from the RN 470, and transmits corresponding upstream optical signals to the RN 470.

The CO 410 includes first to N^{th} TRXs 420-1 to 420-N, a BTX 430, an AMP 435, and a multiplexer/demultiplexer (MUX/DEM) 440 comprised of both a wavelength division multiplexer (WDM) 445 and a hybrid WSC (HWSC) 450.

The first to N^{th} TRXs 420-1 to 420-N have the same structure, where the N^{th} TRX 420-N includes an N^{th} DTX 422-N for outputting the N^{th} downstream optical signal having an N^{th} waveform λ_{N}, an N^{th} URX 424-N for optoelectronic-converting a 2N^{th} upstream optical signal having a 2N^{th} waveform λ_{2N}, and an N^{th} WSC 426-N for outputting an input upstream or downstream optical signal through its corresponding port. The N^{th} WSC 426-N has first to third ports, where the first port is connected to an N^{th} DP of the MUX/DEM 445, the second port is connected to the N^{th} DTX 422-N, and the third port is connected to the N^{th} URX 424-N. The N^{th} WSC 426-N outputs, through its first port, the N^{th} downstream optical signal input through the second port and outputs, through its third port, the 2N^{th} upstream optical signal input through the first port. The N^{th} downstream optical signal is constituted of first to K^{th} timeslots forming one cycle, where the K^{th} timeslot is allocated to the K^{th} ONU 530-N-K of an N^{th} group 530-N.

The AMP 435 amplifies the 3N^{th} downstream optical signal input from the BTX 430 with a preset gain and outputs the amplified 3N^{th} downstream optical signal to the third port of the HWSC 450. The AMP 435 may include an EDFA including an EDF, a laser diode outputting pumping light for pumping the EDF, and a WSC for providing the pumping light to the EDF.

The WDM 445, which includes an MP connected to a second port of the HWSC 450 and first to N^{th} DPs connected one-to-one to the first to N^{th} TRXs 420-1 to 420-N, multiplexes first to N^{th} downstream optical signals input through the first to N^{th} DPs, and then outputs the multiplexed downstream optical signal through the MP. The WDM 445 also demultiplexes a multiplexed upstream optical signal input through the MP, and outputs the demultiplexed upstream optical signals through the first to N^{th} DPs. The WDM 445 may include a 1×N AWG.

The HWSC 450 has first to third ports. The first port is connected to the FF 460. The second port is connected to the MP of the WDM 445. The third port is connected to the AMP 435. The HWSC 450 multiplexes (or combines) the multiplexed downstream optical signal input through the second port and the 3N^{th} downstream optical signal for broadcasting input through the third port, outputs the multiplexed downstream optical signal through the first port, and outputs, through its second port, a multiplexed upstream optical signal input through the first port.

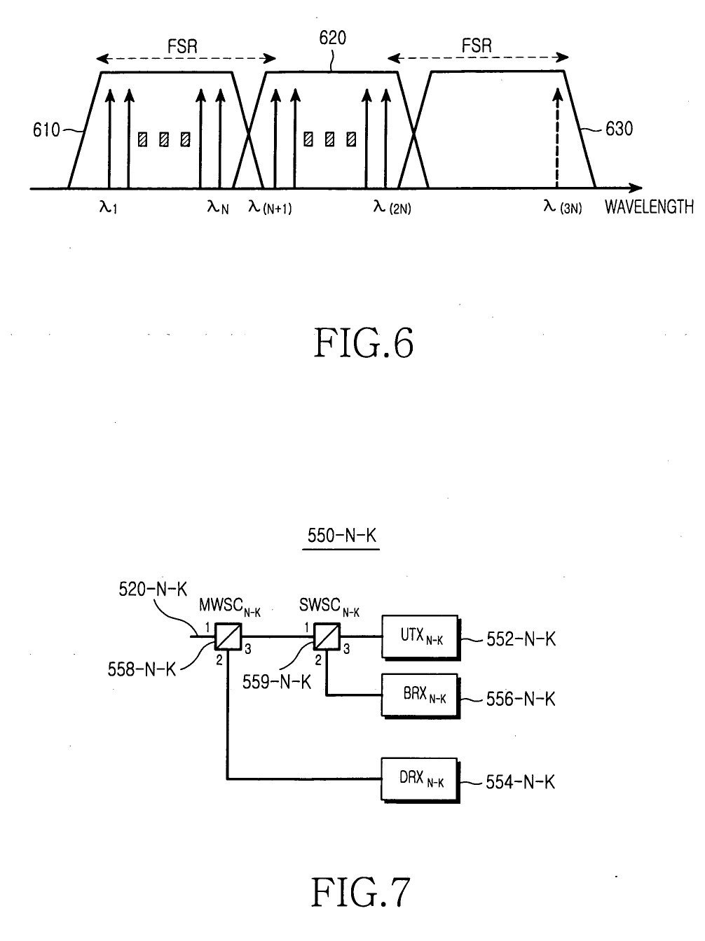

FIG. 6 is a diagram illustrating wavelength bands used in the hybrid WDM/TDM-PON. A downstream wavelength band 610, an upstream wavelength band 620, and a broadcasting wavelength band 630 for downstream transmission do not overlap. Each of the downstream, upstream, and broadcasting wavelength bands 610, 620, 630 is constituted of N wavelengths, each separated by a preset wavelength interval. Each bandwidth of the downstream, upstream, and broadcasting wavelength bands 610, 620, and 630 is equal, in length, to an FSR of the WDM 445, for concurrent handling by the WDM.

If necessary, the downstream, upstream, and broadcasting wavelength bands 610, 620, and 630 can be separated by an integer times the FSR. In addition, the downstream and upstream wavelength bands 610 and 620 can be exchanged.

The RN 470 includes a MUX/DEM 480 comprised of a HWSC 485 and a WDM 490, first to N^{th} MBSs 500-1 to 500-N, and a SBS 510.

The HWSC 485 has first to third ports, where the first port is connected to the FF 460, the second port is connected to an MP of the WDM 490, and the third port is connected to the SBS 510. The HWSC 485 outputs the multiplexed downstream optical signal for communication input through the first port through the second port, outputs the 3N^{th} downstream optical signal for broadcasting input through the first port through the third port, and outputs, through its first port, a multiplexed upstream optical signal input through the second port.

The WDM 490, which includes an MP connected to the second port of the HWSC 485 and first to N^{th} DPs, demultiplexes the multiplexed downstream optical signal input through the MP, and then outputs the demultiplexed downstream optical signals through the first to N^{th} DPs. The WDM 490 also multiplexes (N+1)^{th} to 2N^{th} upstream optical signals input through the first to N^{th} DPs, and then outputs the multiplexed upstream optical signal through the MP. The N^{th} downstream optical signal is outputted through the N^{th} DP. The WDM 490 may include a 1×N AWG.

The first to N^{th} MBSs 500-1 to 500-N, which have the same structure, are connected one-to-one to the first to N^{th} DPs of the WDM 490 and connected to the SBS 510, such that the N^{th} MBS 500-N is connected to the N^{th} DP of the WDM 490. The N^{th} MBS 500-N includes first and second CPs on one end and first to K^{th} SPs on the other end. The first CP is connected to the N^{th} DP of the WDM 490, the second CP is connected to the SBS 510, and the first to K^{th} SPs are connected one-to-one to first to K^{th} DFs 520-N-1 to 520-N-K of an N^{th} group 520-N. Specifically, the K^{th} SP is connected to the K^{th} DF 520-N-K. The N^{th} MBS 500-N equally power-splits each of the N^{th} and 3N^{th} downstream optical signals into K downstream optical signals, and then outputs the K power-split downstream optical signals through the first to K^{th} SPs, respectively. The N^{th} MBS 500-N also multiplexes (or combines) upstream optical signals having a 2N^{th} wavelength input through the first to K^{th} SPs, and then outputs the multiplexed 2N^{th} upstream optical signal through the first CP.

The SBS 510 includes a CP on one end and first to N^{th} SPs on the other end. The CP is connected to the third port of the HWSC 485, and the first to N^{th} SPs are connected one-to-one to first to N^{th} MBSs 500-1 to 500-N, such that the N^{th} SP is connected to the N^{th} MBS 500-N. The SBS 510 equally power-splits the 3N^{th} downstream optical signal input through the CP into N downstream optical signals and then outputs the N power-split downstream optical signals through the first to N^{th} SPs, respectively.

The first to N*K^{th} ONUs 530-1-1 to 530-N-K, which have the same structure, are classified into first to N^{th} groups 530-1 to 530-N. The N^{th} group 530-N is connected to the N^{th} MBS 500-N and includes first to K^{th} ONUs 530-N-1 to 530-N-K.

The K^{th} ONU 530-N-K of the N^{th} group 530-N includes a K^{th} UTX 532-N-K for outputting an upstream optical signal having the 2N^{th} wavelength at an allocated K^{th} timeslot, a K^{th} DRX 534-N-K for selectively receiving a downstream optical signal corresponding to the allocated K^{th} timeslot from the input N^{th} downstream optical signal and optoelectronic-converting the received downstream optical signal, a K^{th} BRX 536-N-K for receiving and optoelectronic-converting the input 3N^{th} downstream optical signal, a K^{th} MWSC 538-N-K for outputting an input upstream or downstream optical signal through its corresponding port, and a K^{th} SWSC 539-N-K for separating the downstream optical signal for communication and the downstream optical signal for broadcasting.

The K^{th} MWSC 538-N-K has first to third ports. The first port is connected to the K^{th} DF 520-N-K of the N^{th} group 520-N. The second port is connected to the K^{th} UTX 532-N-K. The third port is connected to a first port of the K^{th} SWSC 539-N-K. The K^{th} MWSC 538-N-K outputs, through its third port, the N^{th} and 3N^{th} downstream optical signals input through the first port and outputs, through its first port, the 2N^{th} upstream optical signal input through the second port.

The K^{th} SWSC 539-N-K has first to third ports, where the first port is connected to the third port of the K^{th} MWSC 538-N-K, the second port is connected to the K^{th} BRX 536-N-K, and the third port is connected to the K^{th} DRX 534-N-K. The K^{th} SWSC 539-N-K outputs, through its third port, the N^{th} downstream optical signal of the N^{th} and 3N^{th} downstream optical signals input through the first port, so that the 3N^{th} downstream optical signal remains, and outputs the remaining 3N^{th} downstream optical signal through the second port.

If necessary, an optical isolator can be inserted between the HWSC 485 included in the RN 470 and the SBS 510 in order to suppress crosstalk between upstream optical signals. More specifically, in a case where each of the first to N^{th} MBSs 500-1 to 500-N outputs each upstream optical signal input through the first to K^{th} SPs through the first and second CPs by dividing it equally, the optical isolator can block the (N+1)^{th} to 2N^{th} upstream optical signals output from the CP of the SBS 510.

Though the TDM scheme is illustrated in the present embodiment, the SCM scheme can be selected. In particular, the upstream and downstream transmitters and the upstream and downstream receivers can be configured to transmit and receive SCM, rather than TDM, optical signals.

In addition, the ONU is not limited to the present embodiment and can be configured variously by making processing wavelengths of the MWSC and the SWSC different.

FIG. 7 is a block diagram of a K^{th} ONU 550-N-K of an N^{th} group according to another preferred embodiment of the present invention. The K^{th} ONU 550-N-K can be substituted for the K^{th} ONU 530-N-K of the N^{th} group 530-N shown in FIG. 5. The K^{th} ONU 550-N-K includes a K^{th} UTX 552-N-K for outputting an upstream optical signal having a 2N^{th} wavelength at an allocated K^{th} timeslot, a K^{th} DRX 554-N-K for selectively receiving a downstream optical signal corresponding to the allocated K^{th} timeslot from the input N^{th} downstream optical signal and optoelectronic-converting the received downstream optical signal, and a K^{th} BRX 556-N-K for receiving and optoelectronic-converting the input 3N^{th} downstream optical signal. It further includes a K^{th} MWSC 558-N-K for outputting an input upstream or downstream optical signal through its corresponding port, and a K^{th} SWSC 559-N-K for outputting an upstream optical signal for communication and a downstream optical signal for broadcasting through their corresponding ports, respectively.

The K^{th} MWSC 558-N-K has first to third ports, such that the first port is connected to the K^{th} DF 520-N-K of the N^{th} group 530-N, the second port is connected to the K^{th} DRX 554-N-K, and the third port is connected to a first port of the K^{th} SWSC 559-N-K. The K^{th} MWSC 558-N-K outputs, through its second port, the N^{th} downstream optical signal input through the first port. It also outputs, through its third port, the 3N^{th} downstream optical signal input through the first port. Finally, through its first port, it outputs the 2N^{th} upstream optical signal input through the third port.

The K^{th} SWSC 559-N-K has first to third ports, where the first port is connected to the third port of the K^{th} MWSC 558-N-K, the second port is connected to the K^{th} BRX 556-N-K, and the third port is connected to the K^{th} UTX 552-N-K. The K^{th} SWSC 559-N-K outputs, through its second port, the 3N^{th} downstream optical signal input through the first port, and outputs, through its first port, the 2N^{th} upstream optical signal input through the third port.

As described above, in a hybrid PON according to embodiments of the present invention, efficiency of optical fiber can be increased by bi-directionally transmitting optical signals using one feeder fiber, a broadcasting service can be provided to a plurality of subscribers at a low price by a simple structure, and either the WDM/TDM scheme or the WDM/SCM scheme can be supported.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A hybrid passive optical network (PON) comprising:
a central office (CO) for multiplexing a downstream optical signal for broadcasting and a plurality of downstream optical signals for communication;
a remote node (RN) connected to the CO using at least one feeder fiber (FF); and
a plurality of optical network units (ONUs) connected to the RN by respective distribution fibers (DFs),
wherein the RN demultiplexes the multiplexed downstream optical signal received from the CO into the downstream optical signal for broadcasting and the downstream optical signals for communication, multi-splits the downstream optical signal for broadcasting to create split downstream optical signals for broadcasting, and transmits ones of said split downstream optical signals for broadcasting to associated ones of the plural ONUs, said ones of the plural ONUs receiving corresponding signals of the demultiplexed downstream optical signals for communication.

2. The hybrid PON of claim 1, wherein said RN transmits each of the created split downstream optical signals for broadcasting to a respective one of said plural ONUs, said respective one of said plural ONUs receiving correspondingly one of said demultiplexed downstream optical signals for communication.

3. The hybrid PON of claim 1, wherein the RN comprises:
a main beam splitter (MBS) that receives one of the plural downstream optical signals for communication, said MBS being connected to one of said plural ONUs; and
a secondary beam splitter (SBS) that receives said downstream optical signal for broadcasting for demultiplexing, said MBS receiving part of the demultiplexed output of said SBS.

4. The hybrid PON of claim 1, wherein the RN comprises:
a multiplexer/demultiplexer (MUX/DEM) for demultiplexing the multiplexed downstream optical signal received from the CO into the downstream optical signal for broadcasting and the downstream optical signals for communication;
a secondary beam splitter (SBS) for multi-splitting the downstream optical signal for broadcasting input from the MUX/DEM; and
a plurality of main beam splitters (MBSs) respectively connected one-to-many to corresponding ones of the plural ONUs and transmitting respectively said ones of said split downstream optical signals for broadcasting, and ones of said corresponding signals, to said associated ones of the plural ONUs by means of the one-to-many connections.

5. The hybrid PON of claim 4, wherein the MUX/DEM comprises:
a hybrid wavelength selective coupler (HWSC) for demultiplexing said multiplexed downstream optical signal input from the CO into a multiplexed downstream optical signal for communication and said downstream optical signal for broadcasting; and
a wavelength division multiplexer (WDM) for demultiplexing said multiplexed downstream optical signal for communication into said downstream optical signals for communication.

6. The hybrid PON of claim 1, wherein the CO comprises:
a plurality of transceivers (TRXs) each for independently outputting its corresponding one of said downstream optical signals for communication;
a broadcasting transmitter (BTX) for outputting said downstream optical signal for broadcasting; and
a MUX/DEM for multiplexing said downstream optical signal for broadcasting and said downstream optical signals for communication.

7. The hybrid PON of claim 6, wherein the MUX/DEM comprises:
a WDM for multiplexing said downstream optical signals for communication input from the TRXs; and
an HWSC for multiplexing the downstream optical signals for communication and the downstream optical signal for broadcasting.

8. The hybrid PON of claim 1, wherein an ONU of said associated ones of the plural ONUs comprises:
an upstream transmitter (UTX) for outputting an upstream optical signal;
a downstream receiver (DRX) for receiving a signal of the downstream optical signals for communication;
a broadcasting receiver (BRX) for receiving a corresponding one of said split downstream optical signals for broadcasting;
a main wavelength selective coupler (MWSC) for transmitting said upstream optical signal input from the UTX to the RN and passing said signal of the downstream optical signals for communication and said corresponding one of said split downstream optical signals for broadcasting input from the RN; and
a secondary wavelength selective coupler (SWSC) for outputting said signal that has passed through the MWSC to the DRX and outputting said corresponding one that has passed through the MWSC to the BRX.

9. The hybrid PON of claim 1, wherein an ONU of said associated ones of the plural ONUs comprises:
a UTX for outputting an upstream optical signal;
a DRX for receiving a signal of the downstream optical signals for communication;
a BRX for receiving a corresponding one of said split downstream optical signals for broadcasting;
a MWSC for inputting said upstream optical signal and transmitting the inputted upstream optical signal to the RN, outputting, to the DRX, said signal of the downstream optical signals for communication input from the RN, and passing said corresponding one input from the RN; and
a SWSC for outputting said signal that has passed through the MWSC to the BRX and outputting the upstream optical signal input from the UTX to the MWSC.

10. A remote node (RN) connected to a central office (CO) for multiplexing a downstream optical signal for broadcasting and a plurality of downstream optical signals for communication, said RN receiving the multiplexed signal, said RN comprising:
a main beam splitter (MBS) that receives one of the plural downstream optical signals derived by demultiplexing said multiplexed signal, said MBS being connected to an optical network unit (ONU); and
a secondary beam splitter (SBS) that receives said downstream optical signal for broadcasting for demultiplexing, said MBS receiving part of the demultiplexed output of said SBS.

11. A method for optical communication comprising:
providing a central office (CO) for multiplexing a downstream optical signal for broadcasting and a plurality of downstream optical signals for communication;
providing a remote node (RN) connected to the CO using at least one feeder fiber (FF); and
providing a plurality of optical network units (ONUs) connected to the RN by respective distribution fibers (DFs),
wherein the RN demultiplexes the multiplexed downstream optical signal received from the CO into the downstream optical signal for broadcasting and the downstream optical signals for communication, multi-splits the downstream optical signal for broadcasting to create split downstream optical signals for broadcasting, and transmits ones of said split downstream optical signals for broadcasting to associated ones of the plural ONUs, said ones of the plural ONUs receiving corresponding signals of the demultiplexed downstream optical signals for communication.

12. The method of claim 11, wherein said RN transmits each of the created split downstream optical signals for broadcasting to a respective one of said plural ONUs, said respective one of said plural ONUs receiving correspondingly one of said demultiplexed downstream optical signals for communication.

13. The method of claim 1, wherein the RN comprises:
a main beam splitter (MBS) that receives one of the plural downstream optical signals for communication, said MBS being connected to one of said plural ONUs; and
a secondary beam splitter (SBS) that receives said downstream optical signal for broadcasting for demultiplexing, said MBS receiving part of the demultiplexed output of said SBS.

14. The method of claim 11, wherein the RN comprises:
a multiplexer/demultiplexer (MUX/DEM) for demultiplexing the multiplexed downstream optical signal received from the CO into the downstream optical signal for broadcasting and the downstream optical signals for communication;
a secondary beam splitter (SBS) for multi-splitting the downstream optical signal for broadcasting input from the MUX/DEM; and
a plurality of main beam splitters (MBSs) respectively connected one-to-many to corresponding ones of the plural ONUs and transmitting respectively said ones of said split downstream optical signals for broadcasting, and ones of said corresponding signals, to said associated ones of the plural ONUs by means of the one-to-many connections.

15. The method of claim 14, wherein the MUX/DEM comprises:
a hybrid wavelength selective coupler (HWSC) for demultiplexing said multiplexed downstream optical signal input from the CO into a multiplexed downstream optical signal for communication and said downstream optical signal for broadcasting; and
a wavelength division multiplexer (WDM) for demultiplexing said multiplexed downstream optical signal for communication into said downstream optical signals for communication.

16. The method of claim 11, wherein the CO comprises:
a plurality of transceivers (TRXs) each for independently outputting its corresponding one of said downstream optical signals for communication;
a broadcasting transmitter (BTX) for outputting said downstream optical signal for broadcasting; and
a MUX/DEM for multiplexing said downstream optical signal for broadcasting and said downstream optical signals for communication.

17. The method of claim 16, wherein the MUX/DEM comprises:
a WDM for multiplexing said downstream optical signals for communication input from the TRXs; and
an HWSC for multiplexing the downstream optical signals for communication and the downstream optical signal for broadcasting.

18. The method of claim 11, wherein an ONU of said associated ones of the plural ONUs comprises:
an upstream transmitter (UTX) for outputting an upstream optical signal;
a downstream receiver (DRX) for receiving a signal of the downstream optical signals for communication;
a broadcasting receiver (BRX) for receiving a corresponding one of said split downstream optical signals for broadcasting;
a main wavelength selective coupler (MWSC) for transmitting said upstream optical signal input from the UTX to the RN and passing said signal of the downstream optical signals for communication and said corresponding one of said split downstream optical signals for broadcasting input from the RN; and
a secondary wavelength selective coupler (SWSC) for outputting said signal that has passed through the MWSC to the DRX and outputting said corresponding one that has passed through the MWSC to the BRX.

19. The method of claim 11, wherein an ONU of said associated ones of the plural ONUs comprises:
a UTX for outputting an upstream optical signal;
a DRX for receiving a signal of the downstream optical signals for communication;
a BRX for receiving a corresponding one of said split downstream optical signals for broadcasting;
a MWSC for inputting said upstream optical signal and transmitting the inputted upstream optical signal to the RN, outputting, to the DRX, said signal of the downstream optical signals for communication input from the RN, and passing said corresponding one input from the RN; and
a SWSC for outputting said signal that has passed through the MWSC to the BRX and outputting the upstream optical signal input from the UTX to the MWSC.

20. A method of optical communication, comprising:
connecting a remote node (RN) to a central office (CO);
multiplexing, in the CO, for subsequent transmission to the RN, a downstream optical signal for broadcasting and a plurality of downstream optical signals for communication;
receiving, by a main beam splitter (MBS) of the RN, one of the plural downstream optical signals for communication derived by demultiplexing the multiplexed signal received by the RN;
receiving, by a secondary beam splitter (SBS) of the RN, for subsequent demultiplexing, said downstream optical signal for broadcasting;
receiving, by said MBS, part of the demultiplexed output of said SBS; and
connecting said MBS to an optical network unit (ONU) for receiving output of the MBS.
